(19) United States
(12) Patent Application Publication
(10) Pub. No.: US 2009/0000718 A1
(43) Pub. Date: Jan. 1, 2009

(54) Air barrier composition

(76) Inventors: Dirk Frans Rouckhout, Linter (BE); Walter Harvey Waddell, Pasadena, TX (US)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 11/823,711

(22) Filed: Jun. 28, 2007

(51) Int. Cl. B60C 5/00; C08K 5/17; C08K 5/35

(52) U.S. Cl. 152/511; 152/510; 524/252; 524/96

(57) ABSTRACT

Improved air barrier compositions using alternative processing oils are disclosed that reduce the air permeability of the innerliner compound without affecting other properties such as cure, processing, and other physical properties.

### FIELD OF THE INVENTION

The invention relates to halobutyl rubber innerliner formulations.

### BACKGROUND OF THE INVENTION

Halobutyl rubbers are isobutylene-based elastomers and include bromobutyl rubber, chlorobutyl rubber and branched (“star-branched”) halogenated butyl rubbers. Halobutyl rubbers can be formulated for specific applications, such as innertubes or innerliners for tires, and are the polymers of choice for air-retention in tire innerliners for passenger, truck/bus, and aircraft applications. See, for example, EP 0 127 998.

Exxpro™ elastomers (ExxonMobil Chemical Company, Houston, Tex.) are halogenated random copolymers of isobutylene and para-methylstyrene, and have been of particular interest due to their improvements over butyl rubbers. A blend of Exxpro™ elastomers with secondary elastomers or other polymers affords a compound having a desirable balance of properties achieved through suitable processing windows. See, e.g., U.S. Pat. No. 5,386,864.

The tire industry continually seeks improvements to past applications. Processing properties of the green (uncured) composition in the tire plant versus in-service performance of the cured tire composite are important. A continuing in-service problem in the tire industry is the ability to improve the endurance of tires for applications used in a wide variety of conditions such as is required for agricultural tires, aircraft tires, earthmover tires, heavy-duty truck tires, mining tires, motorcycle tires, medium truck tires, and passenger car tires. The performance of the tire innerliner under a variety of temperature conditions is important since any cracking can compromise the desirably low air permeability required.

Thus, the problem of improving air impermeability properties, the flex fatigue properties, or the adhesion to adjoining tire components of elastomeric compositions without affecting the processability of the uncured elastomeric compositions or while maintaining or improving the physical property performance of the cured elastomeric compositions useful for tire articles still remains.

The selection of ingredients and additives for the final commercial formulation depends upon the balance of properties desired, namely, processability and tack of the green (uncured) compound in the tire plant versus the in-service performance of the cured tire composite. Examples of elastomers used are butyl (isobutylene-isoprene rubber or IIR), bromobutyl (brominated isobutylene-isoprene rubber or BIIR), chlorobutyl (chlorinated isobutylene-isoprene rubber or CIIR), star-branched butyl (SBB), Exxpro™ elastomers (brominated isobutylene-co-p-methyl-styrene copolymer or BIMSM), etc. Also important are processing oils, such as naphthenic oils.

Alternatives to traditional processing oils are continually sought in order to improve air barrier performance with no adverse affects on cure or other performance properties, such as discussed in WO 2005017013.

The present inventors have surprisingly discovered processing oils that reduce the air permeability of the innerliner compound without affecting other properties such as cure, processing, and other physical properties.

### SUMMARY OF THE INVENTION

The invention is directed to halobutyl rubber composition comprising from about 3 to about 70 parts by weight of MES and TDAE process oils, per 100 parts by weight of halobutyl rubber.

In an embodiment, the composition is used as an innerliner or innertube in agricultural tires, aircraft tires, earthmover tires, heavy-duty truck tires, mining tires, motorcycle tires, medium truck tires, and passenger car tires.

These and other objects, features, and advantages will become apparent as reference is made to the following detailed description, preferred embodiments, examples, and appended claims.

### BRIEF DESCRIPTION OF THE DRAWINGS

In the accompanying drawings, like reference numerals are used to denote like parts throughout the several views.

FIG. 1 illustrates air permeability of the alternative processing oils used in halobutyl innerliners relative to naphthenic oil.

FIG. 2 illustrates relative aged physical properties of the alternative processing oils used in halobutyl innerliners relative to naphthenic oil.

### DETAILED DESCRIPTION

The invention is directed to a rubber composition comprising from about 3 to about 70 parts by weight of at least one process oil selected from MES and TDAE, per 100 parts by weight of halobutyl rubber.

In a preferred embodiment, the composition will comprise about 4 to about 50 parts by weight of at least one process oil selected from MES and TDAE, per 100 parts by weight of halobutyl rubber.

In another preferred embodiment, the composition will comprise about 4 to about 26 parts by weight of at least one process oil selected from MES and TDAE, per 100 parts by weight of halobutyl rubber.

In yet another preferred embodiment, the composition will comprise about 20 to about 50 parts by weight of at least one process oil selected from MES and TDAE, per 100 parts by weight of halobutyl rubber.

In yet another preferred embodiment, the composition will comprise about 24 to about 70 parts by weight of at least one process oil selected from MES and TDAE, per 100 parts by weight of halobutyl rubber.

The process oils of the invention are selected from MES and TDAE process oils, which are per se known in the art as, for instance, mineral oil softeners. Such mineral oil softeners are, e.g., MES (mild extraction solvate), produced by solvent extraction of heavy oil distillates or by treating heavy oil distillates with hydrogen in the presence of catalysts (hydration) and which are preferably used in the rubber composition according to the invention due to its presently higher availability, or TDAE (treated distillate aromatic extract). With regard to these mineral oil softeners, V. Null, “Safe Process Oils for Tires with Low Environmental Impact”, Kautschuk Gummi Kunststoffe, Dec. 1999, S. 799-805, EP 0 940 462 A2, and U.S. Pat. No. 6,822,043.

Generally, all MES and TDAE oils can be used that are known to one skilled in the art, preferably those fulfilling the criteria of mineral oil softeners with a content of polycyclic aromatic compositions (PCA—content) of less than 3 wt % with relation to the total weight of the mineral oil softener, determined by the DMSO-extract according to the IP 346 method, and have a glass transition temperature below −45° C.

The halobutyl rubber is selected from the group consisting of bromobutyl rubber, chlorobutyl rubber and branched (“star-branched”) halogenated butyl rubbers, and halogenated random copolymers of isobutylene and para-methylstyrene.

A commercial embodiment of a suitable halogenated butyl rubber of the present invention is Bromobutyl 2222 (ExxonMobil Chemical Company, Houston, Tex.). Its Mooney viscosity is from 27 to 37 (ML 1+8 at 125° C., ASTM D1646, modified), and the bromine content is from 1.8 to 2.2 wt % relative to the Bromobutyl 2222. Further, cure characteristics of Bromobutyl 2222 are as follows: MH is from 28 to 40 dN·m, ML is from 7 to 18 dN·m (ASTM D2084).

A commercial embodiment of the halogenated star branched butyl rubber of the present invention is Bromobutyl 6222 (ExxonMobil Chemical Company, Houston, Tex.), having a Mooney viscosity (ML 1+8 at 125° C., ASTM D1646) of from 27 to 37, and a bromine content of from 2.2 to 2.6 wt % relative to the halogenated star branched butyl rubber. Further, cure characteristics of Bromobutyl 6222 are as follows: MH is from 24 to 38 dN·m, ML is from 6 to 16 dN·m (ASTM D2084).

A commercial embodiment of the halogenated isobutylene-p-methylstyrene rubber of the present invention is EXXPRO™ elastomers (ExxonMobil Chemical Company, Houston, Tex.), having a Mooney viscosity (ML 1+8 at 125° C., ASTM D1646) of from 30 to 50, a p-methylstyrene content of from 4 to 8.5 wt %, and a bromine content of from 0.7 to 2.2 wt % relative to the halogenated isobutylene-p-methylstyrene rubber.

The compositions according to the invention, in addition to comprising the rubber and at least one processing oil, may optionally comprise:

a) at least one filler, for example, calcium carbonate, clay, mica, silica, silicates, talc, titanium dioxide, starch, wood flower, carbon black, or mixtures thereof;

b) at least one clay, for example, montmorillonite, nontronite, beidellite, volkonskoite, laponite, hectorite, saponite, sauconite, magadite, kenyaite, stevensite, vermiculite, halloysite, aluminate oxides, hydrotalcite, or mixtures thereof, optionally, treated with modifying agents;

c) at least one processing aid, for example, plastomer, polybutene, polyalphaolefin oils, or mixtures thereof;

d) at least one cure package or curative or wherein the composition has undergone at least one process to produce a cured composition;

e) any combination of a-e.

The compositions of this invention optionally include carbon black. The preferred carbon black will have a surface area of less than 40 m²/g and a dibutylphthalate oil absorption of less than 80 cm³/100 gm. Preferred carbon blacks include, but are not limited to N660, N762, N774, N907, N990, Regal 85, and Regal 90. Below Table 1, show properties of useful carbon blacks.

TABLE 1

| | N₂SA, | DBP Absorption, |
|---|---|---|
| Grade | m²/gm | cm³/100 gm |
| N660 | 34 | 90 |
| N754 | 25 | 58 |
| N762 | 26 | 64 |
| N774 | 28 | 70 |
| N787 | 30 | 80 |
| N907 | 10 | 38 |
| N990 | 7 | 42 |
| N991 | 10 | 38 |
| Regal 85 | 23 | 33 |
| Regal 90 | 23 | 32 |
| ARO 60 | 23 | 58 |
| SL 90 | 25 | 58 |

The carbon black having a surface area of less than 40 m²/g and a dibutylphthalate oil absorption of less than 80 cm³/100 gm is typically present at a level of from 10 to 200 phr, preferably 20 to 180 phr, more preferably 30 to 160 phr, and more preferably 40 to 140 phr.

Processing oils were evaluated in a standard tire innerliner formulation containing 100 phr of bromobutyl rubber. See Table 2.

TABLE 2

| | | | Aromat- | | |
|---|---|---|---|---|---|
| Formulation | Naphthenic | Paraffinic | ic | MES | TDAE |
| BROMOBUTYL | 100 | 100 | 100 | 100 | 100 |
| 2222 | | | | | |
| GPF N-660 | 60 | 60 | 60 | 60 | 60 |
| SP 1068 | 4 | 4 | 4 | 4 | 4 |
| STRUKTOL | 7 | 7 | 7 | 7 | 7 |
| 40 MS | | | | | |
| FLEXON 641 | 8 | | | | |
| FLEXON 876 | | 8 | | | |
| MOBILSOL 30 | | | 8 | | |
| FLEXON 683 | | | | 8 | |
| VIVATEC 500 | | | | | 8 |
| Zinc Oxide | 1 | 1 | 1 | 1 | 1 |
| Perkacit | 1.25 | 1.25 | 1.25 | 1.25 | 1.25 |
| MBTS (100%) | | | | | |
| Sulphur | 0.5 | 0.5 | 0.5 | 0.5 | 0.5 |
| Stearic Acid | 1 | | 1 | 1 | 1 |

Flexon™ 641 and Flexon™ 876 are naphthenic and paraffinic process oils available from ExxonMobil Chemical Company, Baytown, Tex. MobilSol 30 is a well-known aromatic process oil. Flexon™ 683 is a type of commercially available MES process oil also available from ExxonMobil. Other examples are known per se in the art, such as Tudalen™ 4225, Vivatec™ 200, and the like. Vivatec™ 500 is a type of commercially available TDAE process oil. Other examples are known per se in the art.

Perkacit MBTS is a well-known organic sulfur curative/accelerator. Additional ingredients are identified with more specificity below. It will be recognized that ingredients such as SP 1068, Struktol 40 MS, zinc oxide, Perkacit MBTS, sulfur, and stearic acid, maybe substituted by numerous alternatives well-known in the art per se.

Below, Table 3, shows several of the components used in the preferred embodiments set forth herein, and commercial sources.

TABLE 3

| Component | Brief Description | Commercial Source |
|---|---|---|
| Bromobutyl | Brominated Poly(isobutylene- | ExxonMobil Chemical |
| 2222 | co-isoprene), Mooney | Company (Houston, TX) |
| | Viscosity (1 + 8, | |
| | 125° C.) of from | |
| | 27-37 MU | |
| SP-1068 | Brominated phenol- | Schenectady International |
| | formaldehyde resin | (Schenectady, NY) |
| Struktol 40 | Mixture of dark aromatic | Struktol Co. of America |
| MS | hydrocarbon resins having a | (Stow, OH) |
| | softening point between | |
| | 50-60° C. and a specific | |
| | gravity of 1.02. | |
| Stearic acid | Cure agent | e.g., C.K. Witco Corp. |
| | | (Taft, LA) |
| Sulfur | Cure agent | e.g., R.E. Carroll |
| | | (Trenton, NJ) |

### Test Methods

Cure properties were measured using an MDR 2000 at the indicated temperature and 0.5 degree arc. Test specimens were cured at the indicated temperature, typically from 150° C. to 180° C., for a time corresponding to T_{c}90+ appropriate mold lag. When possible, standard ASTM tests were used to determine the cured compound physical properties (see Table 4). Stress/strain properties (tensile strength, elongation at break, modulus values, energy to break) were measured at room temperature using an Instron 4202. Shore A hardness was measured at room temperature by using a Zwick Duromatic. The error (2σ) in measuring 100% Modulus is ±0.11 MPa units; the error (2σ) in measuring elongation is ±13% units.

The values “MH” and “ML” used here and throughout the description refer to “maximum torque” and “minimum torque”, respectively. The “MS” value is the Mooney scorch value, the “ML(1+4)” value is the Mooney viscosity value. The error (2σ) in the later measurement is ±0.65 Mooney viscosity units. The values of “Tc” are cure times in minutes, and “Ts” is scorch time” in minutes.

Tensile measurements were done at ambient temperature on Instron Series IX Automated Materials Testing System 6.03.08. Micro tensile specimens (dog-bone shaped) width of 0.08 inches (0.20 cm) and a length of 0.2 inches (0.5 cm) length (between two tabs) were used. The thickness of the specimens varied and was measured manually by Mitutoyo Digimatic Indicator connected to the system computer. The specimens were pulled at a crosshead speed of 20 inches/min. (51 cm/min.) and the stress/strain data was recorded. The average stress/strain value of at least three specimens is reported. The error (2σ) in tensile measurements is ±0.47 MPa units.

Adhesion was tested using a one-inch strip adhesion, wherein one inch×three inch adhesive bonds to Kraft paper are prepared. Samples are hung horizontally (in peel mode) in an air circulating oven and a 100 gram weight is suspended from the free end of the bond. The oven temperature is raised 10° F. (4.1° C.) every 15 minutes. The peel-fail temperature is the average of three readings.

The error in the fatigue-to-failure values is +20%.

Air permeability was tested by the following method. Thin, vulcanized test specimens from the sample compositions were mounted in diffusion cells and conditioned in an oil bath at 65° C. The time required for air to permeate through a given specimen is recorded to determine its air permeability. Test specimens were circular plates with 12.7-cm diameter and 0.38-mm thickness. The error (2σ) in measuring air permeability is ±0.245 (×10⁸) units. Other test methods are described in Table 4. Table 3 provides properties and commercial sources of some of the ingredients used herein.

TABLE 4

| Parameter | Units | Test |
|---|---|---|
| Mooney Viscosity | ML 1 + 8, 125° C., MU | ASTM D1646 |
| (polymer) | | (modified) |
| Mooney Viscosity | ML 1 + 4, 100° C., MU | ASTM D1646 |
| (composition) | | |
| Air permeability | cm³-cm/cm²-sec-atm | See text |
| Mooney Scorch Time | Tₛ10, 125° C., minutes | ASTM D1646 |
| Moving Die Rheometer | | |
| (MDR) @ | | |
| 180° C., ±0.5° arc | | |
| ML | deciNewton · meter | |
| MH | dNewton· m | |
| Tₛ2 | minute | |
| T_{c}90 | minute | |
| Cure rate | dN · m/minute | ASTM D2084 |
| Physical Properties press | | |
| cured Tc 90 + 2 min | | |
| @ 160° C. | | |
| Hardness | Shore A | ASTM D2240 |
| Modulus 100% | MPa | ASTM D412 die C |
| Tensile Strength | MPa | |
| Elongation at Break | % | |
| Energy to Break | N/mm | |
| Tear Strength | N/mm | ASTM D624 |
| Die B & Die C | | |

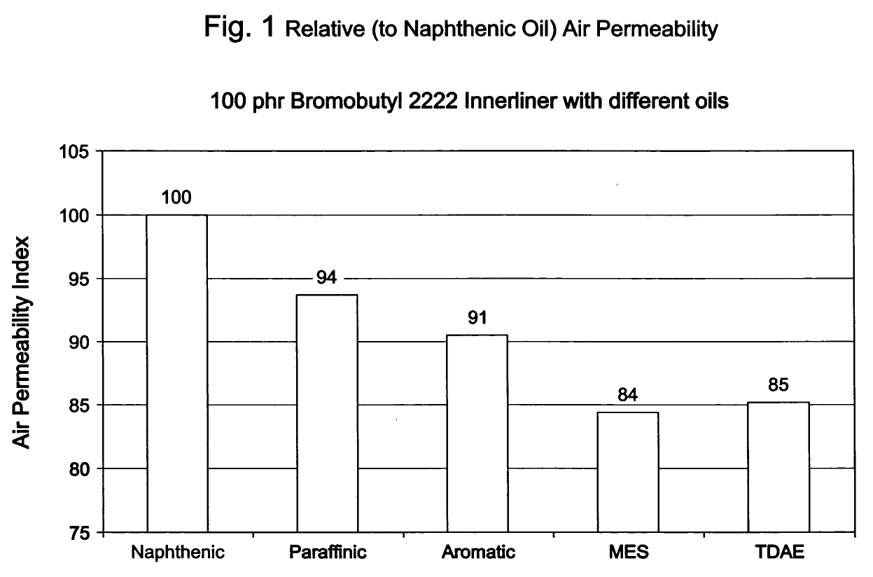

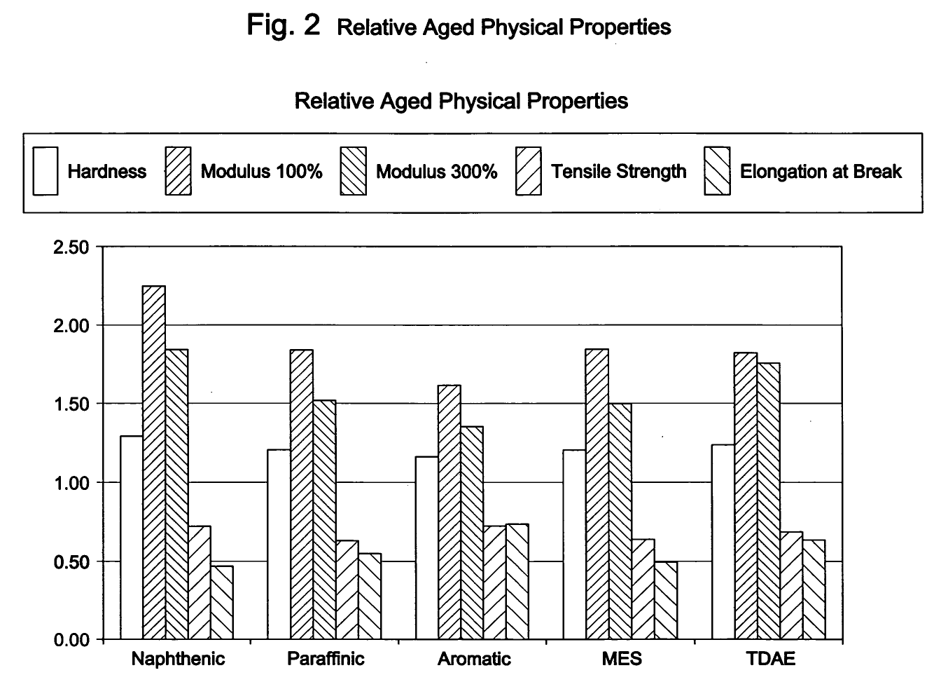

Cure, physical, and aged properties are shown in Table 5 and also in FIGS. 1 and 2.

TABLE 5

| Formulation | Naphthenic | Paraffinic | Aromatic | MES | TDAE |
|---|---|---|---|---|---|
| Processing Properties | | | | | |
| Mooney Viscosity | | | | | |
| ML 1 + 4 at 100° C. | 51.7 | 52.0 | 54 | 54 | 53 |
| Mooney Scorch | | | | | |
| MS T5 at 135° C. (min) | 13.5 | 13.9 | 12.9 | 12.8 | 13.7 |
| Cure Properties | | | | | |
| Arc 0.5, 15 min @180° C. | | | | | |
| ML (dN · m) | 5.13 | 5.07 | 5.01 | 5.17 | 4.88 |
| MH (dN · m) | 1.07 | 1.07 | 1.11 | 1.13 | 1.06 |
| Ts2, Scorch (min) | 1.73 | 1.77 | 1.70 | 1.69 | 1.81 |
| T50, Cure (min) | 1.74 | 1.77 | 1.67 | 1.70 | 1.76 |
| T90, Cure (min) | 4.62 | 4.66 | 4.80 | 4.58 | 4.57 |
| Physical Properties | | | | | |
| Hardness Shore A | 47.9 | 47.1 | 50.1 | 48.0 | 47 |
| Modulus 100% (MPa) | 1.3 | 1.3 | 1.3 | 1.3 | 1.1 |
| Modulus 300% (MPa) | 3.4 | 3.5 | 3.7 | 3.8 | 2.8 |
| Tensile Strength (MPa) | 8.9 | 9.7 | 9.0 | 9.8 | 9 |
| Elongation at Break (%) | 750 | 778 | 731 | 767 | 777 |
| Monsanto Flex (kc to failure) | 92 | 139 | 164 | 131 | 103 |
| ADHESION to SELF (N/mm) | 30.0 | 33.8 | 35.0 | 28.4 | 37.3 |
| ADHESION to CARCASS (N/mm) | 23.5 | 25.4 | 26.9 | 20.8 | 24.8 |
| PERMEABILITY AT 65° C. | 4.28 | 4.01 | 3.87 | 3.61 | 3.64 |
| Relative Permeability | 1.00 | 0.94 | 0.91 | 0.84 | 0.85 |
| Aged Physical Properties | | | | | |
| (3 days @125° C.) | | | | | |
| Hardness Shore A | 61.6 | 56.7 | 58.3 | 57.8 | 58 |
| Modulus 100% (MPa) | 2.8 | 2.3 | 2.1 | 2.4 | 2 |
| Modulus 300% (MPa) | 6.2 | 5.3 | 5.0 | 5.7 | 4.9 |
| Tensile Strength (MPa) | 6.5 | 6.1 | 6.5 | 6.2 | 6.2 |
| Elongation at Break (%) | 351 | 427 | 535 | 376 | 492 |

Several conclusions can be drawn from the data. Air permeability of compounds with the MES and TDAE processing oils are improved (lower is better) compared to naphthenic oil, as shown in FIG. 1. Cure properties are essentially unaffected. Processing properties (Mooney viscosity and Mooney scorch) are essentially unaffected. Physical properties are essentially unaffected. Aged physical properties are improved since the values do not change as much from corresponding original values (closest to 1.0 is desirable), as seen in Table 5 and FIG. 2.

Trade names used herein are indicated by a ™ symbol or ® symbol, indicating that the names may be protected by certain trademark rights, e.g., they may be registered trademarks in various jurisdictions.

All patents and patent applications, test procedures (such as ASTM methods, UL methods, and the like), and other documents cited herein are fully incorporated by reference to the extent such disclosure is not inconsistent with this invention and for all jurisdictions in which such incorporation is permitted.

When numerical lower limits and numerical upper limits are listed herein, ranges from any lower limit to any upper limit are contemplated. While the illustrative embodiments of the invention have been described with particularity, it will be understood that many variations will suggest themselves to those skilled in this art in light of the above detailed description.

What is claimed is:

1. A rubber composition comprising from about 3 to about 70 parts by weight of at least one process oil selected from MES and TDAE per 100 parts by weight of halobutyl rubber.

2. The rubber composition of claim 1, wherein said halobutyl rubber is selected from the group consisting of bromobutyl rubber, chlorobutyl rubber and branched (“star-branched”) halogenated butyl rubbers, and halogenated random copolymers of isobutylene and para-methylstyrene.

3. The rubber composition of claim 2, wherein said composition is cured.

4. An air barrier made from the cured rubber composition of claim 3.

5. A tire innertube made from the rubber composition of claim 3.

6. A tire innerliner made from the rubber composition of claim 3.

7. A tire comprising the rubber composition of claim 3.
